(19) United States
(12) Patent Application Publication
(10) Pub. No.: US 2025/0386272 A1
(43) Pub. Date: Dec. 18, 2025

(54) TECHNIQUES FOR IMPROVED USER EQUIPMENT CONNECTION INTERVAL TIMING

(71) Applicant: T-Mobile USA, Inc., Bellevue, WA (US)

(72) Inventor: Tommy Yau, Sammamish, WA (US)

(21) Appl. No.: 18/747,250

(22) Filed: Jun. 18, 2024

(51) Int. Cl. H04W 36/14; H04L 65/1016; H04W 76/38; H04W 84/04

(52) U.S. Cl. CPC H04W 36/14; H04L 65/1016; H04W 76/38; H04W 84/042

(57) ABSTRACT

Techniques are described herein for optimizing data service uptime when one or more network services are unavailable as implemented on user equipment (UE). Such techniques may comprise determining, by the UE, that at least one service is inaccessible over a first network, receiving, from a separate computing device, a connection interval value representing a time period for switching from the first network, and using one or more data services accessible over the first network during the time period. The techniques may further comprise disconnecting, by the UE, from the first network once the time period has elapsed and connecting to a second network different from the first network.

### BACKGROUND

In telecommunication, a Public Land Mobile Network (PLMN) may be made up of a combination of wireless communication services offered by a specific operator in a specific country. A PLMN may be made up of a number of different networks offered by a single operator. For example, such a PLMN may include an Internet Protocol Multimedia Subsystem network that provides access to data services as well as a Public Switched Telephone Network that provides access to voice services. Additionally, the PLMN may include a network that operates using one or more cellular network technologies that is configured to provide ingress/egress to various user equipment.

Internet Protocol Multimedia Subsystem (IMS) is an architectural framework defined by the 3rd Generation Partnership Project (3GPP) for delivering Internet Protocol (IP) multimedia to user equipment (UE) of the IMS network. An IMS core network (sometimes referred to as the “IMS core,” the “Core Network (CN),” or the “IM CN Subsystem”) permits wireless and wireline devices to access IP multimedia, messaging, and voice applications and services. IMS allows for peer-to-peer communications, as well as client-to-server communications over an IP-based network.

During a registration procedure with the IMS core network, the UE is assigned a serving call session control function (S-CSCF) node and an application server (AS). These assigned nodes are tasked with serving the UE during a subsequent communication session, and all signaling originating from, and terminating at, the UE during the communication session is to be routed through the assigned nodes of the IMS core.

In a typical PLMN architecture, if a UE is able to connect to a core network (e.g., an IMS core) but is unable to access certain functionality provided by a subnetwork (e.g., voice calling services), that UE may be hard-coded to disconnect from the PLMN in order to attempt to connect to other networks that can provide the service. In such cases, the UE may be configured to remain connected to the core network for a predetermined period of time before disconnecting from the PLMN and attempting the connection with the second network.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 depicts a diagram illustrating an overview of a network architecture having a number of components that may be implemented in accordance with some embodiments.

FIG. 2 depicts a component diagram of an example system to be implemented in a network in order to enable implementation of dynamic connection interval values in accordance with some embodiments.

FIG. 3 depicts a block diagram illustrating interactions between various components that may be implemented in a network in accordance with at least some embodiments.

FIG. 4 depicts an exemplary timeline illustrating the providing of data services with implementation of a default connection interval value in accordance with at least some embodiments.

FIG. 5 depicts an exemplary timeline illustrating the providing of data services with implementation of a dynamic connection interval value in accordance with at least some embodiments.

FIG. 6 depicts a flow diagram illustrating an exemplary process for providing intelligent connection retry timing in accordance with at least some embodiments.

### DETAILED DESCRIPTION

This disclosure describes techniques and systems for providing intelligent connection retry timing by UEs that are interacting with a PLMN. In such techniques, UEs may be provided access to dynamic connection interval values that indicate an amount of time that the UE should remain connected to a core network while disconnected from one or more vital services before disconnecting from that core network in order to attempt to connect to a different core network.

In some cases, the UE may retrieve one or more connection interval values from a location in memory of a computing device. In these cases, the UE may retrieve the one or more connection interval values on a periodic basis or upon determining that a connection to one or more network/services is unavailable. In other cases, another computing device may provide one or more connection interval values to the UE (e.g., via a push notification).

In operation, upon determining that the UE is not connected to at least one service/network, the UE may be configured to disconnect from a PLMN after a period of time indicated in one or more connection interval values. In embodiments, the period of time indicated in those one or more connection interval values may be increased or decreased in order to achieve optimization of the utilization of data services for a UE. For example, a first connection interval value associated with connecting to a first (e.g., home) PLMN may be increased while a second connection interval value associated with connecting to a second (e.g., roaming) PLMN may be decreased in order to optimize uptime for data services provided by the first PLMN.

Embodiments of the disclosure provide for a number of advantages over conventional systems. For example, the implemented system allows for improvements to providing data services when some functionality (e.g., voice services) are unavailable. In some systems, UEs may be hard coded to switch between networks when certain services are unavailable. For example, even if a UE has access to data services over an IMS network, that same UE will typically be programmed to switch away from its connection to that IMS network if voice services are unavailable. In this example, the UE may remain connected to the IMS network (during which time it may use data services) for a period of time (e.g., a connection interval) before disconnecting from the IMS network to attempt connection with another network. Continuing with this example, if the UE is unable to establish connection with another network that can provide the needed services, the UE would then reestablish its connection with the IMS network and the process would repeat.

In the above example, if voice services remain unavailable over an IMS network, then a UE may continuously sever its connection after the connection interval has elapsed, attempt to connect to a second network (e.g., a roaming network) for another (or the same) connection interval, and reestablish its connection to the IMS network, and repeat. In such cases, even though data services may still be available over the IMS network, those data services may only be accessible by the UE while it is connected to the IMS network (e.g., during the connection interval). Hence, data services may be continuously disrupted while voice services are unavailable. It should be noted that while this may result in disruptions to data services, it may be unwise to eliminate the disconnect/reconnect functionality entirely as this would prevent connections to a roaming network by the UE, which could be beneficial.

Embodiments of the disclosure allow for the use of dynamic connection interval values instead of static (e.g., hard-coded connection interval values) in order to minimize disruptions in data services when necessary. The UE is configured to obtain the connection interval values from an external entity (e.g., a network node) rather than rely on a static value stored in memory. For example, if voice services are functioning normally, a default connection interval can be set so that the UE is configured to transfer onto a roaming network with minimal disruption when the UE is out of range of its home network. Alternatively, when voice services are temporarily unavailable on the home network because of a system malfunction, the connection interval can be extended (while decreasing a connection interval for a second network) in order to maximize the amount of up time for data services.

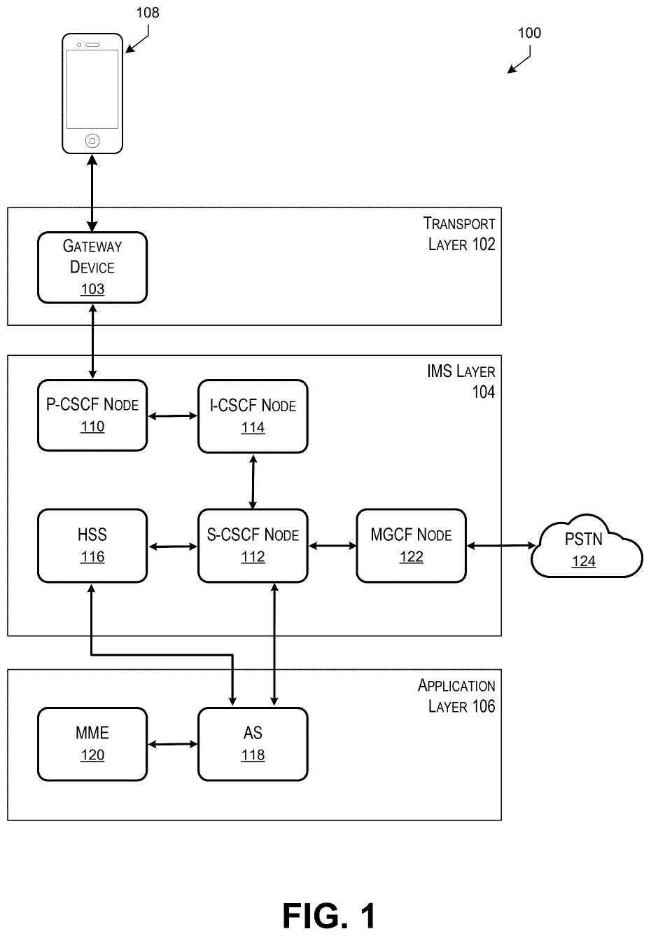

FIG. 1 depicts a diagram illustrating an overview of a network architecture 100 having a number of components that may be implemented in accordance with some embodiments. In embodiments, the network architecture 100 may be made up of multiple layers, each of which includes a different set of nodes. For example, the network architecture 100 may be representative of an IMS network that includes at least a transport layer 102, an IMS layer 104, and an application layer 106.

A transport layer 102 is responsible for connecting different access technologies users' devices to the IMS domain and for connection of the domain to other packet-switched and circuit-switched networks. A transport layer 102 may include any node (e.g., equipment) configured to provide access (e.g., ingress/egress) to the network architecture 100 for a number of user equipment (UE) 108. For example, a transport layer 102 may include a gateway device, such as a gateway device 103 that provides fixed access (e.g., digital subscriber line (DSL), cable modems, Ethernet, FTTx), mobile access (e.g., 5G NR, LTE, W-CDMA, CDMA2000, GSM, GPRS), and/or wireless access (e.g., WLAN, WiMAX).

An IMS layer 104 (also referred to as a control layer) may include any node configured to process SIP signaling packets within the network architecture 100. Such nodes may generally be referred to as Call Session Control Function (CSCF) nodes. CSCF nodes can be further distinguished based on their respective roles. For example, CSCF nodes may include a Proxy CSCF (P-CSCF), a Service CSCF (S-CSCF), and an Interrogating CSCF (I-CSCF). It is to be appreciated that the IMS network can include additional nodes that are not described herein such as nodes including, without limitation, an emergency CSCF (E-CSCF) node, a security gateway (SEG), a session border controller (SBC), and so on. In some cases, the IMS layer 104 may further include a Home Subscriber Server (HSS) 116. However, it should be noted that while the HSS 116 is depicted in the IMS layer 104 in FIG. 1, the HSS 116 may instead be implemented within an application layer 106 in some embodiments of a network architecture 100 or even outside of the IMS network.

A P-CSCF node is a proxy device that acts as a first point of contact for UE 108 within the IMS Network. Each UE is assigned to a respective P-CSCF when it is registered with the IMS Network. A P-CSCF node can receive, via a communications interface, a Session Initiation Protocol (SIP) request from the UE 108 to be forwarded to a S-CSCF.

A S-CSCF node is the central nodes of the signaling plane and sits on the path of all signaling messages to/from a UE 108 that is assigned to it. There can be multiple S-CSCFs in the network for load distribution and high availability reasons. A S-CSCF is typically assigned to a user (or UE) by a Home Subscriber Server (HSS), when it's queried by the I-CSCF.

A S-CSCF node 112 may represent one of multiple available S-CSCF nodes (e.g., 112 (A-C)) that is chosen (or otherwise selected) for assignment to the UE 108. S-CSCF nodes, such as the S-CSCF node 112 (A), are sometimes referred to as “Registrars,” and the process of allocating Registrars among users who are registering for IMS-based services is sometimes referred to as finding a “home CSCF” for the UE 108.

A I-CSCF node 114 is a SIP function node that acts as a forwarding point for external devices. The I-CSCF node 114 queries the HSS to determine S-CSCF/UE mapping and forwards SIP requests between the P-CSCF node 110 and the respective S-CSCF node 112.

The HSS 116 is typically a master user database that supports the IMS network nodes that handle the calls/sessions. It contains user profiles, performs authentication and authorization of the user, and can provide information about the physical location of a user. A user profile may be associated with each UE 108 and may contain information about the current user. Such information may be downloaded by the S-CSCF assigned to the user when the user is registered on the network. The S-CSCF may typically receive that information in a User-data Attribute Value Pair (AVP) format.

An application layer 106 (also referred to as a service layer) may include one or more nodes capable of providing IMS-related services to the UE 108. In embodiments, the application layer 106 may include at least a number of Application Servers (AS) 118, as well as a Mobility Management Entity (MME) 120. As noted above, the application layer 106 may further include a HSS 116 in some embodiments.

An AS 118 hosts and executes services, and interface with the S-CSCF using messages formatted using a SIP protocol. Depending on the actual service, the AS 118 can operate in SIP proxy mode, SIP UA (user agent) mode or SIP B2BUA mode. An AS 118 can be located in the network architecture 100 or in an external third-party network. If located in the network architecture 100, it may be able to query, or otherwise interact with the HSS 116 (e.g., using Diameter interfaces). In embodiments, the AS 118 manages an application that provides communication between two or more UEs (e.g., UE 108 and at least one other UE). For example, the AS 118 may manage an application that provides Voice over IP (VOIP) communications between UE devices.

In embodiments, an AS 118 may be configured to make service initiation decisions based on information about a UE 108 to which a communication is being directed. For example, the AS 118 may receive a communication directed to initiation of a service at a UE 108. By way of illustration, another UE may initiate a Voice over Internet Protocol (VOIP) call to a UE 108. In this illustration, the AS 118 receives a request to initiate the VoIP call as well as an identifier for the UE 108. Upon receiving such a communication, the AS 118 may retrieve information about the UE 108 from a second entity that maintains updated information about a status of the UE 108. Such a communication may be routed through the HSS 116. For example, the AS 118 may provide a request to the HSS 116 (which maintains information about services associated with the account for that UE 108) and the HSS 116 further communicates with an MME 120 to retrieve such information. The AS 118 may then make a determination about whether the service should or should not be initiated based on the received information and absent additional communications within the network architecture 100.

The network architecture 100 may include at least one node that provides a Media Gateway Control Function (MGCF) (e.g., MGCF node 122) that enables interaction between the IMS network and at least one other network, such as a telephonic network (Public Switched Telephone Network (PSTN) 124). In embodiments, a MGCF node 122 may be configured to translate between SIP messaging and other formats in order to facilitate inter-network messaging.

The UE 108 may include any electronic device capable of interacting with the network architecture 100. In some non-limiting examples, the UE 108 may be a variety of devices including, for example: a mobile phone, a personal data assistant (PDA), or a mobile computer (e.g., a laptop, notebook, notepad, tablet, etc.) having mobile wireless data communication capability. The UE 108 may be configured to register for, and thereafter access and utilize, one or more IMS-based services via the network architecture 100. To this end, the UE 108 may be configured to transmit, via a radio access network (RAN), messages to the IMS network. For example, the UE 108 may transmit messages to the IMS network as part of an IMS registration procedure where the UE 108 is requesting to register for an IMS-based service.

The UE 108 may, upon registration with the network architecture 100, be assigned to a P-CSCF node 110 as well as a S-CSCF node 112. Communications from the UE 108 to an AS 118 of the network architecture 100 are then routed from the UE 108 to the P-CSCF node 110 and then to the S-CSCF node 112 (through forwarding by the I-CSCF node 114) and subsequently to the AS 118. Conversely, communications from an AS 118 of the network architecture 100 to the UE 108 are routed from the AS 118 to the S-CSCF node 112 and then to the P-CSCF node 110 and subsequently to the UE 108.

The UE 108 may be capable of operating on multiple different networks. When one network is unavailable, or when some portion of vital functionality is unavailable on a network, the UE 108 may be configured to switch its connection to another detected network. In such cases, the UE 108 may be configured to first wait for some amount of time (e.g., a connection interval) to elapse prior to attempting to connect to the other detected network. It the UE 108 is able to connect to the second network, then it may operate over that network instead of over the IMS network. Provided that the UE 108 is unable to connect to another network (either because no other network can be found or no other network provides the vital services), then the UE 108 may be configured to once more wait for a period of time (e.g., either the same connection interval or a different one) to elapse before reattempting to establish the connection over the IMS network.

During operation, a UE 108 may attempt to initiate a connection with an IMS network via a respective transport layer 102. The UE 108 may make a determination that the IMS network is available, but a second network accessed via the IMS network (e.g., a PSTN 124) is unavailable. In some cases, such a determination may be made if the UE receives an error code or erroneous response in relation to the second network. In some cases, such a determination may be made if the UE does not receive a response within a predetermined amount of time.

Either before or after attempting to connect to the second network through the IMS network and determining that the second network is unavailable, the UE 108 may receive an indication of a connection interval over which subsequent connection requests will be reattempted before disconnecting from the IMS network. In such a scenario, the UE 108 may be configured to remain connected to the IMS network and continue to attempt to connect to the second network over a period of time indicated in the connection interval. During this period of time, the UE 108 may be configured to access services provided by at least one AS 118 using a packet switching (PS) only mode. However, the use of such services would be cut off once the UE 108 disconnects from the IMS network when attempting to connect to a different network.

In accordance with various embodiments described herein, the terms “user equipment (UE).” “wireless communication device,” “wireless device,” “communication device,” “mobile device,” and “client device,” may be used interchangeably herein to describe any UE (e.g., the UE 108) that is capable of transmitting/receiving data over the IMS network, perhaps in combination with other networks. A users can utilize the UE 108 to communicate with other users and associated UEs via the IMS network. For example, a service provider may offer multimedia telephony services that allow a subscribed user to call or message other users via the IMS network using his/her UE 108. A user can also utilize the UE 108 to receive, provide, or otherwise interact with various different IMS-based services by accessing the IMS network. In this manner, an operator of the IMS network may offer any type of IMS-based service, such as, telephony services, emergency services (e.g., E911), gaming services, instant messaging services, presence services, video conferencing services, social networking and sharing services, location-based services, push-to-talk services, and so on.

Furthermore, the IMS network that includes the IMS nodes 110-122 may enable peer-to-peer, client-to-client, and/or client-to-server, communications over wired and/or wireless networks using any suitable wireless communications/data technology, protocol, or standard, such as Global System for Mobile Communications (GSM), Time Division Multiple Access (TDMA), Universal Mobile Telecommunications System (UMTS), Evolution-Data Optimized (EVDO), Long Term Evolution (LTE), Advanced LTE (LTE+), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VOIP), Voice over LTE (VOLTE), IEEE 802.1x protocols, WiMAX, Wi-Fi, Data Over Cable Service Interface Specification (DOCSIS), digital subscriber line (DSL), and/or any future IP-based network technology or evolution of an existing IP-based network technology.

The network architecture 100 of FIG. 1 may be maintained and/or operated by one or more service providers, such as one or more wireless carriers (“operators”), that provide mobile IMS-based services to users (sometimes called “subscribers”) who are associated with UEs, such as the UE 108. The IMS network may represent any type of SIP-based network that is configured to handle/process SIP signaling packets or messages. SIP is a signaling protocol that can be used to establish, modify, and terminate multimedia sessions (e.g., a multimedia telephony call) over packet networks, and to authenticate access to IMS-based services. Individual nodes of the IMS nodes 110-122 of FIG. 1 can also be configured to transmit data to/from the HSS 116 using Diameter protocol over a Diameter interface. In one example, such a Diameter interface may be a Diameter (Cx) when the interface is accessed via a I/S-CSCF node. In another example, such a Diameter interface may be a Diameter (Sh) when the interface is accessed via an application server. Diameter protocol is defined by the Internet Engineering Task Force (IETF) in RFC 6733.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

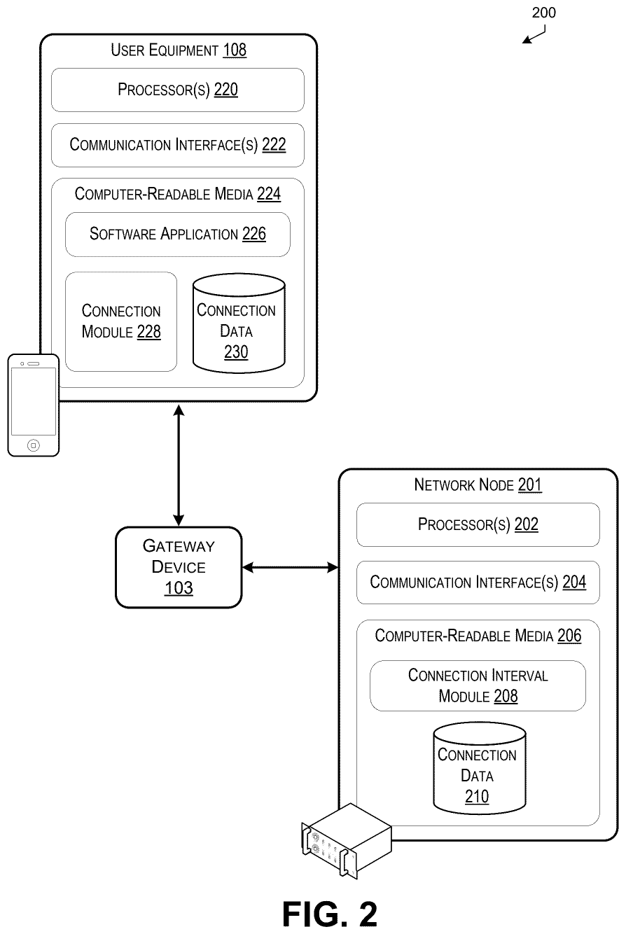

FIG. 2 depicts a component diagram of an example system to be implemented in a network (e.g., an IMS network) in order to enable implementation of dynamic connection interval values in accordance with some embodiments. As depicted in FIG. 2, a network node (e.g., an IMS node operating on an IMS network) 201 may be in wireless communication with a UE 108 that is operated by a user. The connection between the UE 108 and the network node operating on a network may be made over a gateway device 103.

In some embodiments, an exemplary network node 201 may be an example of an IMS node (e.g., 110-122) as described in relation to FIG. 1 above. In some embodiments, the network node 201 is implemented in communication with a gateway device 103. Gateway device 103 may be an example of the gateway device as described in relation to FIG. 1 above. It should be noted that such an IMS node (or any other described computing component) may include a single computing device (e.g., a server device) or a combination of computing devices. In some cases, the IMS node may be implemented as a virtual device/system (e.g., via virtual machines implemented within a cloud computing environment).

As illustrated, the network node 201 may include one or more hardware processors 202 configured to execute one or more stored instructions. Such processor(s) 202 may comprise one or more processing cores. Further, the network node 201 may include one or more communication interfaces 204 configured to provide communications between the network node 201 and other devices, such as the UE 108 or any other suitable electronic device.

The network node 201 may also include computer-readable media 206 that stores various executable components (e.g., software-based components, firmware-based components, etc.). The computer-readable media 206 may store components to implement functionality described herein. While not illustrated, the computer-readable media 206 may store one or more operating systems utilized to control the operation of the one or more devices that comprise the network node 201. According to one instance, the operating system comprises the LINUX operating system. According to another instance, the operating system(s) comprise the WINDOWS® SERVER operating system from MICROSOFT Corporation of Redmond, Washington. According to further embodiments, the operating system(s) can comprise the UNIX operating system or one of its variants. It should be appreciated that other operating systems can also be utilized.

The computer-readable media 206 may include portions, or components, that configure the network node 201 to perform various operations described herein. For example, the computer-readable media 206 may include some combination of components configured to implement the described techniques. Particularly, the network node 201 may include a component configured to generate connection interval values to be provided to one or more UEs (e.g., connection interval module 208). Additionally, the computer-readable media 206 may further maintain one or more databases or other data storage structures that maintain a number of connection interval values generated via the connection interval module 208 (connection data.

A connection interval module 208 may be configured to, when executed by the processors 220, cause the network node 201 to generate a connection interval value that is then provided to a number of UEs 108. Such a connection interval value is generated to optimize uptime for data services provided to one or more UE 108. In some cases, during normal operation, the connection interval module may be configured to provide a default, or standard, connection interval value that represents a time period that strikes a balance between data service uptime and enabling the UE to connect to roaming services. In such cases, a single connection interval value associated with a single time period may be provided to the UE to be used in disconnection/connection processes performed by the UE. In cases that the UE is likely to use the connection interval, that UE may have limited access to the first network and hence switching to a roaming network may be optimal. In contrast, during operation in which a vital service (e.g., a voice service) is unavailable, the connection interval module may be configured to provide UEs with a connection interval value that includes a lengthened time period for remaining connected to the first network and a shortened time period for remaining connected to a second network. Implementation of such a connection interval value can be used to reduce the number (and length) of disconnects from the first network in order to increase uptime of data services made available to the UE.

The UE 108 may be an example of a UE 108 as described in relation to FIG. 1 above. As noted elsewhere, a UE 108 may include any suitable electronic device configured to interact with a network.

Similar to the network node 201, the UE 108 may include one or more hardware processors 220 configured to execute stored instructions. Such processor(s) 220 may comprise one or more processing cores. Further, the UE 108 may include one or more communication interfaces 222 configured to provide communications between the UE 108 and other devices, such as a network node 201 or another suitable electronic device.

Similar to the network node 201, the UE 108 may include computer-readable media 224 that stores various executable components (e.g., software-based components, firmware-based components, etc.). The computer-readable media 224 may store components to implement functionality described herein. It should be appreciated by those skilled in the art that computer-readable storage media may include any available media that provides for the non-transitory storage of data and that can be accessed by the UE 108. In some examples, the operations performed by devices as described herein may be supported by one or more devices similar to UE 108. Stated otherwise, some or all of the operations performed by a UE, and/or any components included therein, may be performed by one or more computing device operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

The computer-readable media 224 may include portions, or components, that configure the UE 108 to perform various operations described herein. For example, the computer-readable media 224 may include some combination of components configured to implement the described techniques. In embodiments, the computer-readable media 224 of the UE 108 may include one or more software application 226, each of which may perform some functionality that relies upon data services accessed over a network. The computer-readable media 224 may further include a component configured to schedule disconnection/connection attempts after detecting unavailability of a vital service (e.g., connection module 228). Additionally, the computer-readable media 224 may further maintain one or more databases, such as a database of information maintained in relation to time periods for making disconnection/connection attempts (e.g., connection data 230).

A software application 226 may be any suitable set of computer-executable instructions that causes the UE 108 to perform a function. In embodiments, the software application 226 may be supported by a remote server, such as an AS 118 as described in relation to FIG. 1 above. In other words, when executed, the software application may cause the UE 108 to communicate with a remote server to perform at least a portion of the functionality provided by that software application 226. The network traffic generated during such a communication may be transmitted to the gateway device 103 to be routed to its intended destination device.

A connection module 228 may be configured to, upon determining that one or more vital services is unavailable, cause the UE 108 to disconnect from a first network and attempt to establish a connection with a second network. More particularly, the connection module 228 may be configured to retrieve a connection interval value from another entity (e.g., network node 201) and implement a wait process over a time period indicated in that connection interval value. The connection module 228 may be configured to continue to attempt to access the vital service over the time period. If, after the time period has elapsed, the vital service is still inaccessible, then the connection module 228 may be configured to disconnect from the first network and establish a connection with at least one second network.

In some cases, the UE 108 may receive updated connection data 230 from one or more network nodes operating on a network. In some cases, the connection data 230 is received periodically (e.g., every hour). In other cases, the connection data 230 is pushed to the UE 108 by one or more devices operating on the network as that connection data 230 is updated.

Many UEs may be voice centric, in that they require access to voice services in order to operate. Hence, in a scenario in which voice services are unavailable on a network, even if data services are still available on that network, the UE may be configured to disconnect from that network in order to attempt to connect to a different (i.e., second) network that has the voice services available.

During operation, the UE may, while connected to a first network (e.g., a first PLMN) make a determination that one or more vital services is unavailable. For example, the UE may determine that while a core network that provides data services is available, a PSTN that provides voice services is unavailable (e.g., overloaded or offline). In some cases, the UE may have already been connected to the first network and may make a determination that the one or more vital services has just become unavailable/unresponsive. In other cases, the UE may make a determination that the one or more vital services is unavailable upon establishing a connection with the first network.

In the above operation, the connection module 228 of the UE 108 may, upon making the determination that the one or more vital services is unavailable, cause the UE 108 to schedule a disconnection from the first network after a time period has elapsed. As noted elsewhere, the time period may be determined from a connection interval value received from another entity (e.g., network node 201) and stored in connection data 230. The UE may continue to attempt to reestablish access to the vital service over that time period. Until the time period has elapsed, the software applications 226 operating on the UE 108 may continue to use data services provided over the first network (e.g., via one or more application servers operating on the first network). In some cases, the UE 108 may operate in a packet-switch (PS)-only mode, in which only data services are provided, during that time period.

As noted elsewhere, upon expiration of the time period, the UE 108 may be caused to disconnect from the first network and attempt to connect to a second network accessible by that UE. In some cases, the UE 108 may be unable to access a second network (e.g., there may be no second network accessible to the UE 108). In such cases, the UE may immediately reestablish its connection to the first network, though note that its data services would have still been interrupted. If the UE 108 does have to access a second network, then that UE may establish a connection to that second network. If the UE 108 is unable to access to each of a number of vital services over the second network, then the connection module 228 of the UE 108 may, cause the UE 108 to schedule a disconnection from the second network after a second time period has elapsed. The second time period may be equal to, or different from, the time period associated with the first network.

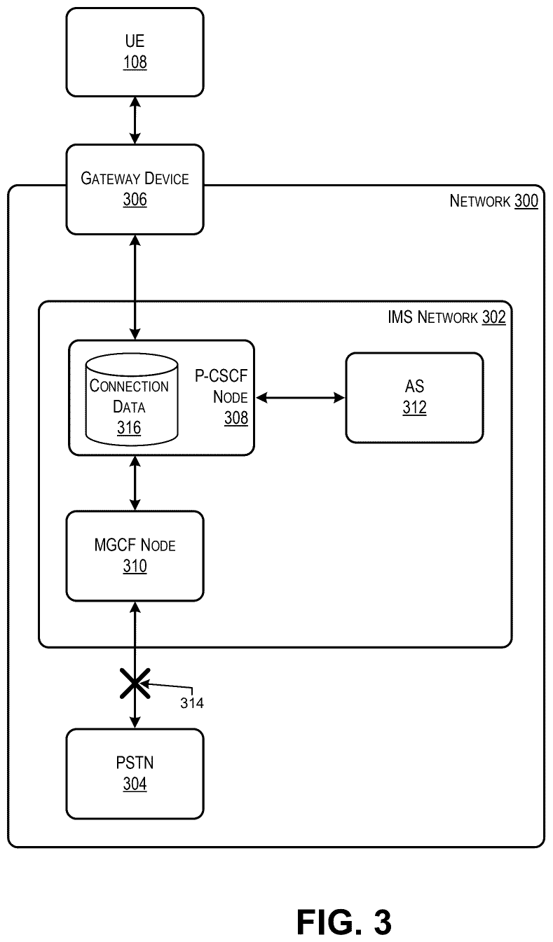

FIG. 3 depicts a block diagram illustrating interactions between various components that may be implemented in a network 300 in accordance with at least some embodiments. As depicted, a network 300 (which may be a PLMN as described elsewhere) may include a number of components, including an IMS network 302 that provides data services within the network 300 and a PSTN 304 that provides voice services within the network 300. Additionally, the network 300 may be accessed via one or more gateway device 306 that provides ingress/egress for one or more UE 108 to the network 300. In some embodiments, the gateway device may include a cellular network that provides cellular services to the one or more UE 108.

As noted elsewhere, the IMS network 300 may include a number of node devices, such as P-CSCF node 308 as well as MGCF node 310. It should be noted that the IMS network 302 may include a number of other node device types that are not depicted in FIG. 3, such as S-CSCF nodes, I-CSCF nodes, etc. Additionally, the IMS network 302 may include one or more AS 312 configured to provide data services in relation to the network 300.

In embodiments, a UE 108 may interact with the network 300 via a gateway device 306. Through the gateway device 306, the UE may connect to a P-CSCF node 308 that is assigned to that UE 108 during a registration process.

In the exemplary network 300, data services may be provided to the UE 108 via one or more AS 312 that is accessed over the IMS network 302 via a connection through the P-CSCF node 308. In contrast, voice services may be provided to the UE 108 via a PSTN 304 in communication with the IMS network 302. In embodiments, the PSTN 304 may connect to one or more MGCF node 310 of the IMS network 302 that is configured to translate data from a format usable by the IMS network (e.g., SIP requests) into a format usable by the PSTN 304 and vice versa.

As would be recognized, if voice services provided via the PSTN 304 becomes unavailable (e.g., as determined via a communication/data packet failure at 314), data services may still be available to the UE 108. Accordingly, even thought the UE 108 may be configured to disconnect from the network 300 if the voice services are unavailable, it may be advantageous for the UE 108 to continue to access the data services provided by that same network.

As noted elsewhere, the UE 108 may retrieve connection data 316 from a location in memory within the network 300. In some cases, this location in memory may be a location in the memory of the P-CSCF node 308. In other cases, this location in memory may be a location in the memory of the gateway device 306. For example, one or more nodes operating on the IMS network 302 may provide the connection data 316 to a gateway device 306.

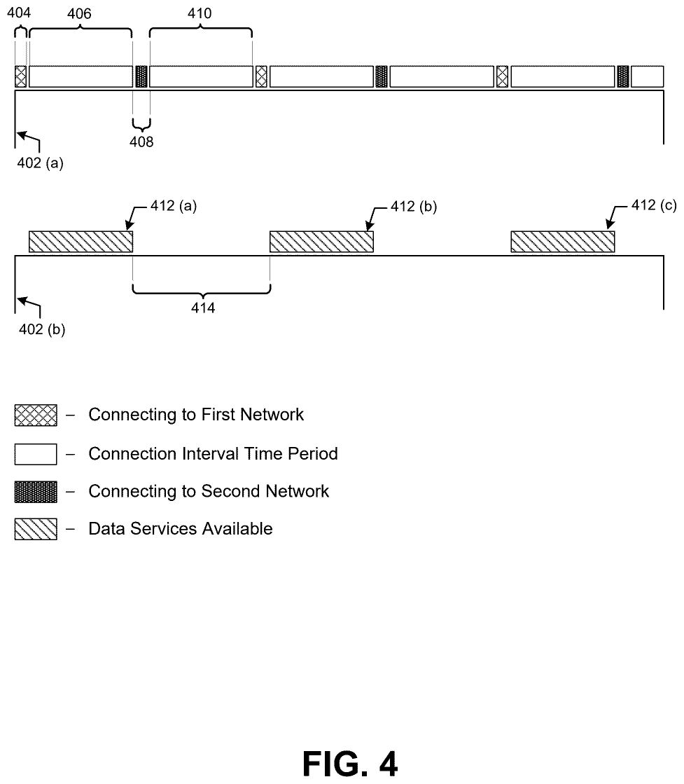

FIG. 4 depicts an exemplary timeline illustrating the providing of data services with implementation of a default connection interval value in accordance with at least some embodiments. In FIG. 4, timeline 402 (e.g., 402 (a) and 402 (b)) may represent a period of time during which a UE is capable of communicating with at least two separate networks (e.g., a first network and a second network). In some cases, the first network may be a home network operated by a single carrier whereas the second network may be a roaming network operated by a different carrier.

For the purposes of FIG. 4, consider a scenario in which the UE does not have access to one or more vital services over either the first network or the second network. Initially, the UE may connect to the first network during a connection phase 404. Upon connecting to the first network, the UE may determine that it is not able to access the one or more vital services (e.g., voice service) as noted above. The UE may then determine time period 406 associated with a connection interval value to be implemented in association with the first network. In this scenario, consider that the connection interval value represents a default connection interval value that may be implemented with respect to both the first and second network.

Upon making the above determinations, the UE may enter a PS only mode in which data services are enabled even if voice services are unavailable. Additionally, the UE begins a timer that corresponds to the time period 406. The UE then operates in PS only mode over the duration of the time period 406. The UE may periodically attempt to access the vital service during the time period 406 and may exit the PS only mode and stop the timer if access to the vital service is restored.

Once the time period has elapsed as indicated by the timer, the UE may be configured to disconnect from the first network. The UE may then connect to the second network during a connection phase 408. Upon connecting to the second network, the UE may determine once more that it is not able to access the one or more vital services. The UE may then determine time period 410 associated with a connection interval value to be implemented in association with the second network. In this scenario, consider that the connection interval value represents the default connection interval value and the time period 410 is equal to the time period 406.

Once more, the UE may enter a PS only mode and begin a second timer that corresponds to the time period 410. The UE then operates in PS only mode for the time period 410. As above, the UE may periodically attempt to access the vital service during the time period 410 and may exit the PS only mode and stop the timer if access to the vital service is restored. Once the time period 410 has elapsed, the UE may disconnect from the second network and once more connect to the first network, restarting the process.

As would be recognized by one skilled in the art, implementation of a default connection interval value by a UE in the manner illustrated would result in data service uptimes 412 (a-c) during which data services are available to the UE over the first network with service interruptions 414 occurring at periodic intervals (e.g., when the UE is not connected to the first network).

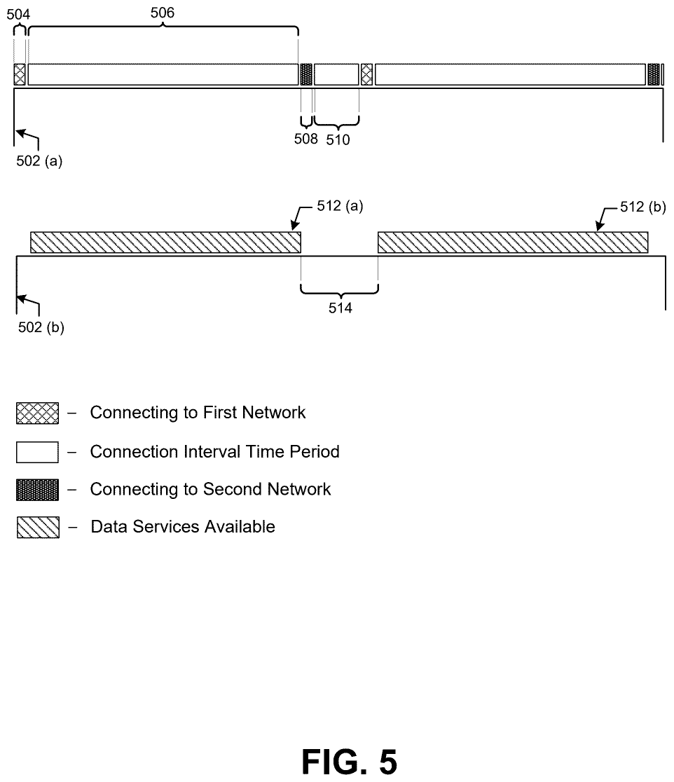

FIG. 5 depicts an exemplary timeline illustrating the providing of data services with implementation of a dynamic connection interval value in accordance with at least some embodiments. Similar to FIG. 4, timeline 502 (e.g., 502 (a) and 502 (b)) may represent a period of time during which a UE is capable of communicating with at least two separate networks (e.g., a first network and a second network). As above, the first network may be a home network operated by a single carrier whereas the second network may be a roaming network operated by a different carrier.

For the purposes of FIG. 5, consider the above scenario in which the UE does not have access to one or more vital services over either the first network or the second network. Initially, the UE may connect to the first network during a connection phase 504. Upon connecting to the first network, the UE may determine that it is not able to access the one or more vital services (e.g., voice service) as noted above. The UE may then determine time period 506 associated with a connection interval value to be implemented in association with the first network. In this scenario, consider that the connection interval value represents a an extended connection interval value that may be implemented with respect to only the first (home) network.

Upon making the above determinations, the UE may enter a PS only mode and begins a timer that corresponds to the time period 506. The UE then operates in PS only mode over the duration of the time period 506 while continuing to attempt to access the vital service. As above, the UE may exit the PS only mode and stop the timer if access to the vital service is restored.

Once the time period 506 has elapsed as indicated by the timer, the UE may be configured to disconnect from the first network. The UE may then connect to the second network during a connection phase 508. Upon connecting to the second network, the UE may determine once more that it is not able to access the one or more vital services. The UE may then determine time period 510 associated with a connection interval value to be implemented in association with the second network. In this scenario, consider that the connection interval value represents a shorter time period intended to result in less disruption to data services.

Once more, the UE may enter a PS only mode and begin a second timer that corresponds to the time period 510. The UE then operates in PS only mode for the time period 510. As above, the UE may periodically attempt to access the vital service during the time period 510 and may exit the PS only mode and stop the timer if access to the vital service is restored. Once the time period 510 has elapsed, the UE may disconnect from the second network and once more connect to the first network, restarting the process.

As would be recognized by one skilled in the art, implementation of an extended connection interval value by a UE for the first network along with a shortened connection interval value for the second network in the manner illustrated would result in data service uptimes 512 (a-b) during which data services are available to the UE over the first network with service interruptions 514 occurring at periodic intervals (e.g., when the UE is not connected to the first network). It should be noted that the total uptime of data services as represented by 512 of FIG. 5 is greater than the total uptime of data services as represented by 412 of FIG. 4. Additionally, the service interruptions represented by 514 of FIG. 5 are shorter and less frequent than the service interruptions represented by 414 of FIG. 4.

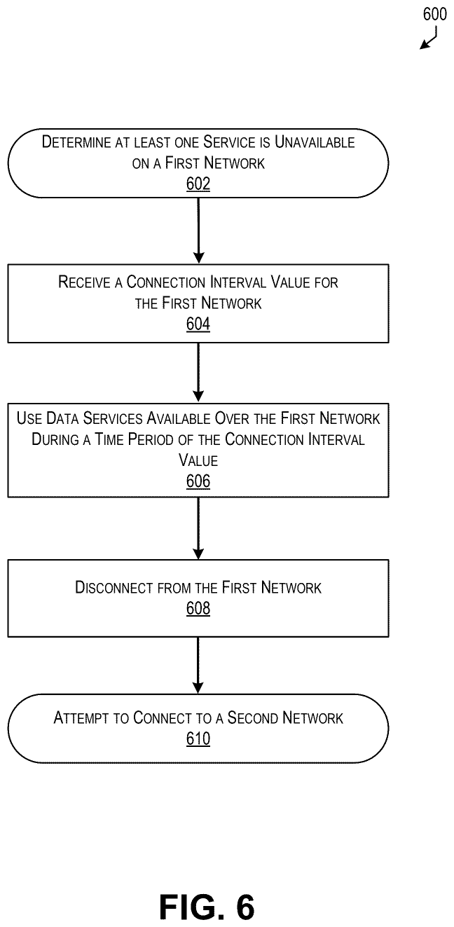

FIG. 6 depicts a flow diagram illustrating an exemplary process for providing intelligent connection retry timing in accordance with at least some embodiments. In embodiments, the process 600 as depicted in FIG. 6 may be performed by a UE in communication with a network. In some embodiments, a first network comprises a public land mobile network (PLMN). In cases, the PLMN may include an IP Multimedia Subsystem (IMS) network and a Public Switched Telephone Network (PSTN). In some cases, a first network is operated by a first carrier and a second network is operated by a second carrier that is different from the first carrier.

At 602, the process 600 may involve determining at least one service is unavailable on a first network. In some embodiments, the at least one service may be at least a voice service that is typically accessible over the first network. In some cases, the at least one service is determined to be inaccessible over the first network upon the UE receiving a response associated with the at least one service that includes an error code. In other cases, the at least one service is determined to be inaccessible over the first network upon the UE failing to receive a response associated with the at least one service.

At 604, the process 600 may involve receiving a connection interval value associated with the first network. In embodiments, the connection interval value may include an indication of a time period (or other indication of an amount of time) over which the UE should remain connected to the first network before disconnecting from it. In some cases, the connection interval value is received after determining that the at least one service is inaccessible. For example, the UE may retrieve the connection interval value in response to determining that the service is unavailable. In other cases, the connection interval value is received via a periodic update. For example, the UE may periodically check a location associated with the connection interval value and may retrieve data that is currently stored in that location.

At 606, the process 600 may involve using one or more data services during the time period. In some cases, the UE operates in a packet-switch (PS) only mode during the time period.

At 608, the process 600 may involve disconnecting from the first network. In some cases, the UE may continue to attempt to access the at least one service during the time period. If the UE is able to access the at least one service during the time period, then the UE may cancel the disconnection from the first network. At 610, provided that the UE is unable to access the at least one service during the time period, the process 600 may involve attempting to connect to a second network.

In embodiments, the process 600 may further involve determining that the at least one service is inaccessible over the second network. Upon making this determination, the UE may receive, from the separate computing device, a second connection interval value representing a second time period for switching from the second network, the second time period different from the time period, and disconnect from the second network once the second time period has elapsed. In some cases, the first connection interval and the second connection interval are received as connection interval data.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
determining, by a User Equipment (UE), that at least one service is inaccessible over a first network;
receiving, by the UE from a separate computing device, a connection interval value representing a time period for switching from the first network;
using, by the UE, one or more data services accessible over the first network during the time period;
disconnecting, by the UE, from the first network once the time period has elapsed; and
connecting, by the UE, to a second network different from the first network.

2. The method of claim 1, wherein the UE operates in a packet-switch (PS) only mode during the time period.

3. The method of claim 1, further comprising:
determining, by the UE, that the at least one service is inaccessible over the second network;
receiving, by the UE from the separate computing device, a second connection interval value representing a second time period for switching from the second network, the second time period different from the time period; and
disconnecting, by the UE, from the second network once the second time period has elapsed.

4. The method of claim 1, wherein the at least one service comprises at least a voice service that is typically accessible over the first network.

5. The method of claim 1, wherein the connection interval value is received after determining that the at least one service is inaccessible.

6. The method of claim 1, wherein the connection interval value is received via a periodic update.

7. The method of claim 1, wherein the at least one service is determined to be inaccessible over the first network upon receiving a response associated with the at least one service that includes an error code.

8. The method of claim 1, wherein the at least one service is determined to be inaccessible over the first network upon failing to receive a response associated with the at least one service.

9. A User Equipment (UE) device comprising:
one or more processors; and
one or more non-transitory computer-readable media storing computer-executable instructions that, when executed by the one or more processors, cause the UE device to perform operations comprising:
determining that at least one service is inaccessible over a first network to which the UE is connected;
receiving, from a separate computing device, a connection interval value representing a time period for switching from the first network;
using one or more data services accessible over the first network during the time period;
disconnecting from the first network once the time period has elapsed; and
connecting to a second network different from the first network.

10. The UE device of claim 9, wherein the first network comprises a public land mobile network (PLMN).

11. The UE device of claim 10, wherein the PLMN comprises an IP Multimedia Subsystem (IMS) network and a Public Switched Telephone Network (PSTN).

12. The UE device of claim 9, wherein the first network is operated by a first carrier and the second network is operated by a second carrier that is different from the first carrier.

13. The UE device of claim 9, wherein the operations further comprise:
determining that the at least one service is inaccessible over the second network;
receiving, from the separate computing device, a second connection interval value representing a second time period for switching from the second network, the second time period different from the time period; and
disconnecting from the second network once the second time period has elapsed.

14. The UE device of claim 13, wherein the first connection interval and the second connection interval are received as connection interval data.

15. The UE device of claim 9, wherein the operations further comprise continuing to attempt to access the at least one service during the time period.

16. A system comprising:
a first network comprising one or more nodes; and
at least one UE connected to the first network, the at least one UE configured to:
determine that at least one service is inaccessible over the first network;
receive, from the one or more nodes, a connection interval value representing a time period for switching from the first network;
using one or more data services accessible over the first network during the time period; and
disconnecting from the first network once the time period has elapsed.

17. The system of claim 16, wherein the one or more data services accessible over the first network comprises a data service provided by an application server accessible over the first network.

18. The system of claim 16, wherein the one or more nodes are implemented on an IMS network.

19. The system of claim 18, wherein the at least one service comprises a service provided by a separate network accessible over the one or more nodes.

20. The system of claim 19, wherein the separate network comprises a PSTN accessible over the one or more nodes.
